(19) United States
(12) Patent Application Publication
(10) Pub. No.: US 2004/0230684 A1
(43) Pub. Date: Nov. 18, 2004

(54) Context sensitive transfer

(76) Inventor: Brent Smolinski, Chapel Hill, NC (US)

Correspondence Address: PAUL, HASTINGS, JANOFSKY & WALKER LLP, P.O. BOX 919092, SAN DIEGO, CA, 92191-9092, US

(21) Appl. No.: 10/780,915

(22) Filed: Feb. 17, 2004

Related U.S. Application Data
(60) Provisional application No. 60/447,631, filed on Feb. 14, 2003.

(51) Int. Cl. G06F 15/16

(52) U.S. Cl. 709/227

(57) ABSTRACT

A communication system and method are configured to perform context sensitive transfers of a communication session. In one embodiment of the invention, a communication session between a calling party and a receiving party in which the communication session includes a dialog between the calling party and the receiving party is transferred from the receiving party to a third party where the dialog continues between the calling party and the third party.

### RELATED APPLICATIONS INFORMATION

This application claims priority under 35 USC §119 to U.S. Provisional Application Ser. No. 60/447,631, entitled “CONTEXT SENSITIVE TRANSFER,” filed on Feb. 14, 2003, which is incorporated herein by reference as though set forth in full.

### BACKGROUND

1. Field of the Inventions

The field of the invention relates generally to a system for allowing a terminal engaged in a communication session with another terminal to transfer the communication session to a third terminal, particularly during a communication session using instant message (IM) technology, and more particularly in the context of a contact center.

2. Background Information

Instant messaging (IM) technology provides for instant, real-time conversations between two or more interacting terminals that are connected to a system through internal or external networks. Some examples of IM technology networks include AOL Instant Messenger, MSN Instant Messenger, Yahoo! Instant Messenger, Jabber, ICQ, and SMS. These IM networks will typically include the ability to communicate using text messaging and have the notion of presence, but may have neither.

Instant messaging technology has become very popular among users of the Internet and internal intranets. IM networks are easy to operate and provide an efficient mechanism of communication among interacting participants. IM networks are also becoming popular among corporate IM users as corporations have found IM networks particularly useful to execute transactions, interact with enterprise data and applications, and capture real-time business processes both on internal and external networks. Corporations also appreciate the ease of operability of IM networks requiring near zero learning time for employees.

Instant messaging networks are real-time in nature. Unlike e-mail systems, IM networks determine whether a terminal is logged into the IM network and able to receive a message. An IM conversation is a conversation between two or more terminals logged into an IM network that takes place in real-time. An IM conversation can also be defined as a dialog. The term “Terminal” as used herein can refer to the hardware, e.g., computers or computer terminals, telecommunications equipment, etc., used by live persons to participate in, for example, an IM conversation, or to automated software and/or hardware configured for automated engagement in such a conversation or dialog.

In an IM environment, a communication session is the IM conversation or conversations between terminals in its entirety. A communication session between connections of persons to the IM network remains open from the time a person logs in to the time a person logs out. A person-to-person communication session remains open throughout the entire period terminals are logged into the IM network until one or more terminals explicitly terminates the connection.

IM dialogs have become particularly useful when communicating with a contact center. For example, a person can have an IM conversation with an automated self-help application, or “bot”, to get information on a company's product. However, the “bot” may not be programmed to answer all of the person's questions and a live agent must be contacted. In another example, a “bot” or junior employee may collect information from a caller qualifying the caller to speak to a senior employee. Thus, it may be part of the normal business process to move the caller from one agent to another at some point in the IM conversation. In another example, a person is having an IM conversation with a company representative and asks a question. However, the company representative is unable to answer the question, but recognizes that her supervisor knows the answer. Under current practices, conventional systems may be able to transfer the communication sessions to a third party, but are unable to do so efficiently. In most systems, the communication session must be terminated in order for the person to be placed in contact with the live agent or supervisor.

It is therefore sometimes desirable to efficiently transfer the communication session from a “bot” or company representative to another person or agent without terminating the existing IM conversation. Moreover, it is sometimes desirable to transfer, or the information gathered during the communication session, including the person's contact information and questions, to the live agent or supervisor in order to continue the conversation where the “bot” or company representative left off.

### SUMMARY OF THE INVENTION

A communication session between a calling party and a receiving party in which the communication session includes a dialog between the calling party and the receiving party that is transferred from the receiving party to a third party where the dialog continues between the third party and the calling party. Either the calling party or the receiving party can initiate the transfer.

In one aspect, the communication system is configured with a calling party, a receiving party and a third party, in which the receiving party or the calling party is configured to initiate a transfer of the communication session by sending a transfer message to the third party. The third party responds by sending a transfer accept message. The receiving party sends a disconnect message to the calling party and the communication session continues between the calling party and the third party.

In another aspect, a method for transferring a communication session is provided by initiating a transfer from a receiving party by sending a transfer message to the third party and disconnecting the receiving party upon receiving a transfer accept message. The communication session continues between the calling party and the third party.

In another aspect, a transfer protocol of a communication system is configured to disconnect and transfer the communication session between the calling party and the receiving party. The transfer protocol includes a disconnect sequence where either the calling party or the receiving party initiates the disconnection of the other by sending a disconnect message to the other. The transfer protocol also provides a transfer sequence in which the receiving party sends a transfer message to a third party. The third party accepts the transfer and replaces the receiving party so that the communication session continues between the third party and the calling party.

These and other features, aspects, and embodiments of the invention are described in the section entitled “Detailed Description of the Preferred Embodiment.”

### BRIEF DESCRIPTION OF THE DRAWINGS

Preferred embodiments of the present inventions taught herein are illustrated by way of example, and not by way of limitation, in the figures of the accompanying drawings, in which:

FIG. 1 depicts a diagram illustrating an example of a communication system configured to incorporate a protocol management system between one or more calling party terminals, receiving party terminals, or a third party terminals in client server network model;

FIG. 2 depicts an exemplary embodiment of a transfer sequence of a communication session;

FIG. 3 depicts an exemplary embodiment of a connect sequence of a communication session;

FIG. 4 shows a flowchart that illustrates the connect sequence between a calling party and a receiving party;

FIG. 5 depicts an exemplary embodiment of a message sequence of a communication session;

FIG. 6 shows a flowchart that illustrates the message sequence of a communication session;

FIG. 7 depicts an exemplary embodiment of a transfer sequence of a communication session from a receiving party to an external third party.

FIG. 8 shows a flowchart that illustrates the transfer sequence of a communication session;

FIG. 9 depicts an exemplary embodiment of a disconnect sequence of a communication session;

FIG. 10 shows a flowchart that illustrates the disconnect sequence between any of a receiving party, a calling party, and a third party, occurring during a communication session;

FIG. 11 shows a flowchart that illustrates the disconnect sequence between any of a receiving party, a calling party, and a third party, occurring during a communication session;

FIG. 12 depicts an embodiment of a transfer when a calling party of an external messaging network interacts with a receiving party, a natural language application, following which the natural language application initiates a transfer to a third party client on that external network;

FIG. 13 depicts an embodiment of a transfer when a calling party of an external messaging network interacts with a natural language application, with the natural language application initiating a transfer to a third party client on an internal messaging network; and

FIG. 14 depicts an embodiment of a transfer when a calling party is interacting with receiving party on a messaging network and the receiving party initiates a context sensitive transfer to third party where the clients are any mix of people and applications.

### DETAILED DESCRIPTION OF THE PREFERRED EMBODIMENTS

In the descriptions of example embodiments that follow, implementation differences, or unique concerns, relating to different types of systems will be pointed out to the extent possible. But it should be understood that the systems and methods described herein are applicable to any type of network system.

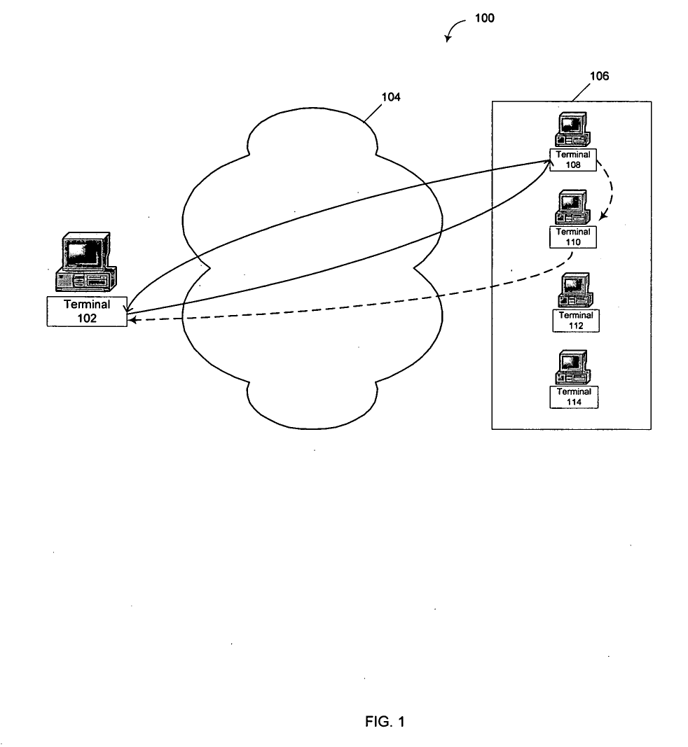

The term “terminal” used to identify a calling party terminals, a receiving party terminals, or a third party terminals, is intended to indicate that the various terminals communicate with each other through the computing systems, hardware and software, associated therewith. Thus, depending on the embodiment, the term terminal may refer to one or more terminals, live person interfaces, automated software and/or hardware routines and systems, servers, such as Internet or web servers, file servers, and/or database servers, computing devices, including but not limited to, workstations, computers and wireless devices, networking components, including but not limited to, routers and databases and software applications, including but not limited to, one or more software applications, one or more Application Program Interfaces (APIs), or some combination thereof. An exemplary embodiment of a communication system comprising one or more terminals is described in more detail with respect to FIG. 1.

FIG. 1 depicts a diagram illustrating an example of a communication system configured to incorporate a protocol management system between one or more calling party terminals, receiving party terminals, or third party terminals in client server network model in accordance with the systems and methods described herein. The network can provide a basic overview of the systems used to implement a distribution platform that can allow the end user to be redirected or transferred efficiently from a receiving party to a third party as described below. Specifically, FIG. 1 depicts a network 100, at least a calling party terminal 102, a receiving party terminal 108, a third party terminal 110, all connected for communication purposes at least via the Internet.

As described herein, a caller can refer to any terminal connected to another terminal. The caller may constitute one or more automated systems, live persons, servers, such as Internet or web servers, file servers, and/or database servers, computing devices, including but not limited to, workstations, computers and wireless devices, networking components, including but not limited to, routers and databases and software applications, including but not limited to, one or more software applications, one or more Application Program Interfaces (APIs), or some combination thereof.

As described herein, a communication session can refer to any conversation or conversations between terminals or callers in its entirety. The communication session can remain open throughout the entire period the terminals are logged into the network and until one or more terminals explicitly terminates the connection. A communication session can constitute any form of communication including, but not limited to, instant messaging.

As described herein, a transfer context can refer to the communication and display of information about the communication session and its participants to a third party upon a transfer of the communication session from a calling party or receiving party to the third party.

As described herein, a space, or shared memory, can be the location where processes communicate and coordinate their activities by exchanging objects. The space can be, but is not limited to, a Java Space or an IBM T Space. In one embodiment, the space can provide the ability to dynamically add a server such as a VoiceXML Browser (VB) or gateway adapter (GA).

As described herein, in one embodiment a gateway adapter (GA) can connect a messaging network or proxy server to the space, described above.

As described herein, in one embodiment a VoiceXML Browser (VB) can interpret natural language applications as written in VoiceXML. In one embodiment, a VB can be referred to as a Natural Language Server. In other embodiments, Perl interpreters, C++, or Java programs can also act as application engines to interpret natural language applications.

As described herein, in one embodiment a voice browser adapter (VBA) can connect a VoiceXML Browser to a space.

As described herein, a client server network model, or network, can include one or more internal networks such as a LAN (local area network), WAN (wide area network), locally switched network, or public switched network, some other communication technique, or some combination thereof, by which devices locally coupled to client server network model can communicate with each other. Although one or more embodiments are described herein in which the client server network model can include a LAN, there is no particular requirement that the client server network model include a LAN, or that any particular network configuration be employed. The client server network model, or network, can include the Internet; however, in other embodiments the client server network model can also include an intranet, extranet, virtual private network (VPN), LAN, WAN, locally switched network or public switched network, some other communication technique, or some combination thereof. Although an embodiment is described herein where the client server network model including the Internet, there is no particular requirement that the client server network model use the Internet or any other specific type of network.

As described herein, a protocol can support communication among processes which make up a communication session. The protocol can support the establishment of connections, transmission of text messages, and control functions. The protocol can, for example, be operated over a reliable transport such as TCP.

As described herein, a protocol management system can efficiently control the communication between the terminals by defining the types of messages used to communicate. In one embodiment, the protocol management system can define a connect message, a connect accept message, a connect reject message, a message message, a transfer message, a transfer accept message, a transfer busy message, a transfer no answer message, a disconnect message, a disconnect acknowledge message, and a status message.

In one embodiment of protocol management system, a connect message can refer to any message or messages sent from one terminal to another to initiate a communication session.

In one embodiment of the protocol management system, a connect accept message can refer to a reply to a connect message indicating that the connection has been established.

In one embodiment of the protocol management system, a message message can refer to any message sent from one terminal to another comprising the text, or body, that can constitute a message, instruction, or inquiry or any other query or statement.

In one embodiment of the protocol management system, a disconnect message can refer to any message sent from one terminal to another to tear down a connection. The disconnect message can comprise status properties or statistics which the VB has collected. The disconnect message can also comprise transfer flag when the disconnect is sent as party of a transfer sequence. The presence of the transfer flag will prevent the disconnect message from being forwarded beyond the VB, and can cause the voice browser adapter (VBA) to directly acknowledge the disconnect to the VB.

In one embodiment of the protocol management system, a disconnect acknowledge message can refer to a reply to the disconnect message. The disconnect acknowledge message can also report statistics regarding status properties when the VB replies to the disconnect message.

In one embodiment of the protocol management system, a status message can refer to any message sent by any terminal and particularly can refer to a message sent by the VBA to the logger when the VB sends a disconnect message or a disconnect acknowledge message. A status message can contain information regarding the session length, session completion, session termination, session begin time, session end time, number of messages in the session, session length, and any other relevant data to the communication session.

In one embodiment of the protocol management system, a transfer message can refer to any message sent by a receiving party or a calling party to a third party to initiate a transfer of the communication session from the receiving party or calling party to the third party. The transfer message can constitute a connect message. The transfer message can comprise the identity of the user who initiated the connection, any data or useful information from the initial dialog between the receiving party and the calling party, to alert the third party accepting the transfer and provide continuity. The data or information in the transfer message can be provided by either the calling party or the receiving party in its capacity of gathering information to or about the calling party. The transfer message can also report the transfer destination defining where the transfer is to be made as either a particular terminal or a class. The transfer report can also comprise the session identification so the third party can take over the connection from the receiving party.

In one embodiment of the protocol management system, a transfer accept message can refer to a reply to the transfer message indicating the third party can accept the transfer. The transfer accept message indicates that the third party is involved in the connection identified by the session identification and that the connection to the receiving party has been terminated. The calling party becomes aware of the transfer upon receiving a message message from the third party. The session identification used by the receiving party is now used by the third party.

In one embodiment of the protocol management system, a transfer busy message can refer to a reply to the transfer message indicating when the third party is already in a connection and cannot accept the transfer.

In one embodiment of the protocol management system, a transfer no answer message can refer to a reply to the transfer message indicating when the third party does not reply to the transfer message.

By way of introduction, the calling can party place a call or sends a message to a call center where a receiving party can answer the call or receives the message and a dialog between the calling party and the receiving party ensues. As will be described below in greater detail, upon receiving an inquiry from the calling party that the receiving party cannot answer, the calling party can transfer the call to a third party, or a third receiving party. The receiving party not only can transfer the call itself to the third party, but also can transfer the communication session including any dialog between the calling party and the receiving party, any information regarding the calling party including, but not limited to, status, location, and identification, and any inquiries the calling party may have that the receiving party could not answer. As such, the third party can continue the call or communication session with the calling party.

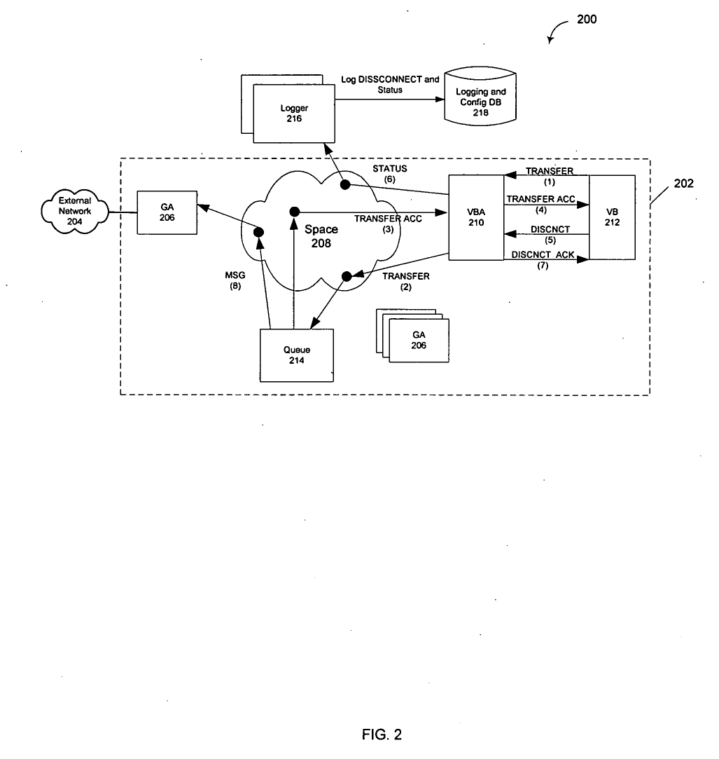

By way of further introduction, FIG. 2 depicts an exemplary embodiment of a transfer sequence of a communication session from a receiving party to a third party in a network 200 configured to interface with a protocol management system 202 in accordance with the systems and methods described herein. In the example of FIG. 2, a VB 212 can send a transfer message to the VBA 210, the VBA 210 can forward the transfer message to the space 208 where it can be picked up by a third party in the queue 214. The third party in the queue 214 then can send the VBA 210 a transfer accept message in reply to the transfer. The VBA 210 then can forward the transfer accept message to the VB 212. The VB 212 then can send a disconnect message to the VBA 210 and can send a disconnect acknowledges message back to the VB 212. The third party in the queue 214 can now connect to the calling party in the external network 204.

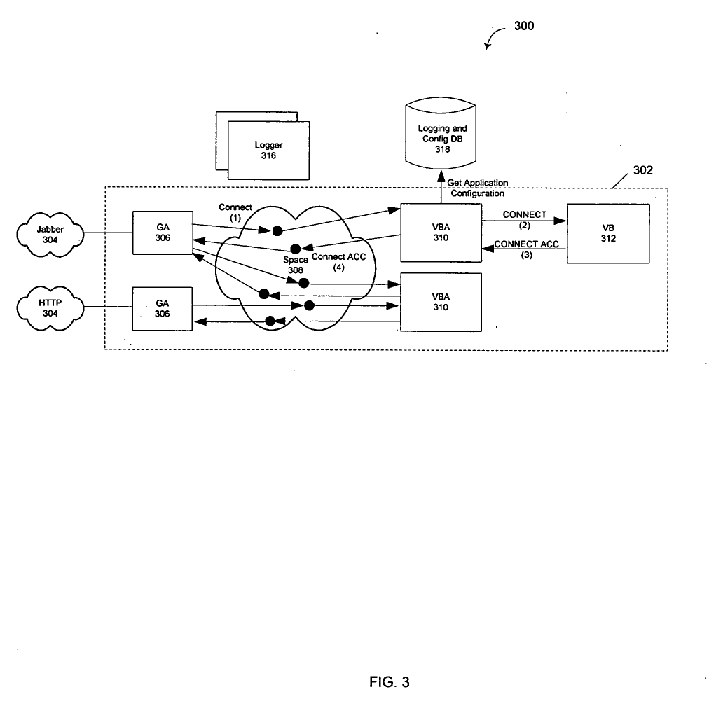

FIG. 3 depicts an exemplary embodiment of a connect sequence of a communication session from a calling party to a receiving party in a network 300 configured to interface with a protocol management system 302 in accordance with the systems and methods described herein. In the example of FIG. 3, through the instant messaging service, Jabber 304, the calling party can send a connect message to the GA 306. The GA 306 can forward the connect message to the space 308 where an available VBA 310 can receive it. The VBA 310 then can forward the connect message to the VB 312. In reply, the VB 312 can send a connect accept message to the VBA 310. The VBA 310 then can forward the connect accept message to the space 308 where the GA 306 can retrieve it and sent it to the calling party.

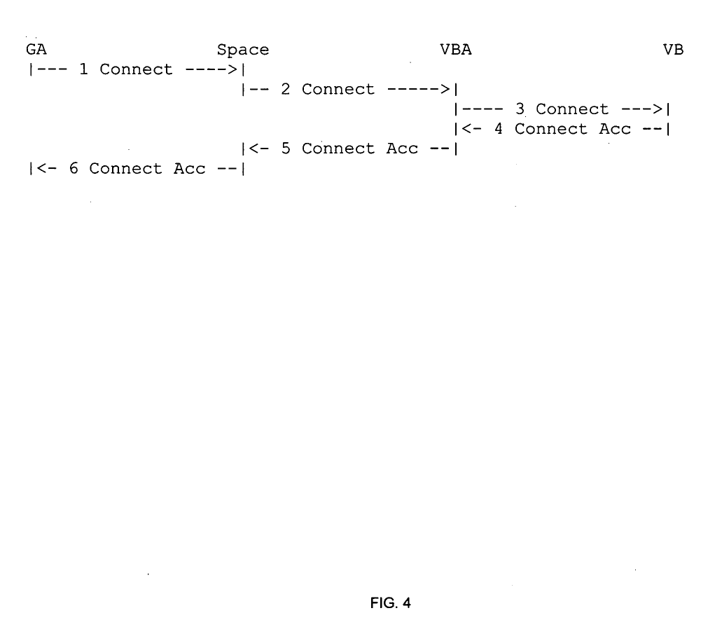

FIG. 4 is a flowchart that illustrates the connect sequence between a calling party and a receiving party. More specifically, FIG. 4 shows the different message types necessary to connect two terminals in a communication session and the intermediary devices that receive and forward the messages.

As shown in FIG. 4, the GA can be contacted by a calling party by sending a message to the GA. The GA and hold the message while it establishes a connection with a VB. The GA can send a connect message addressed to any available VBA to the space. The next available VBA can then retrieve the connect message and can send it to its corresponding VB. The VB can send a connect accept message to the VBA indicating that it is ready for further messages to be sent. The VBA can forward the connect accept message to the space. The GA can pick up the connect accept message from the space and the connection can be established between the calling party and the receiving party.

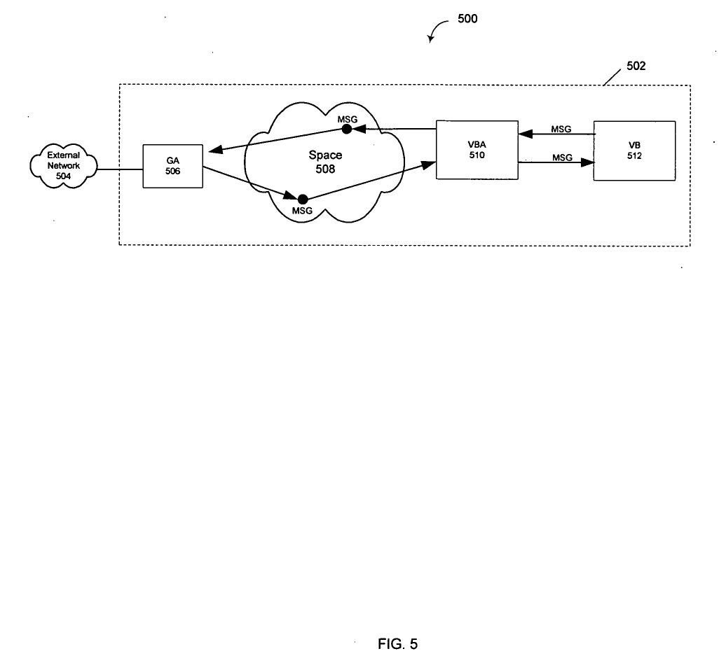

FIG. 5 depicts an exemplary embodiment of a message sequence of a communication session occurring between a calling party to a receiving party in a network 500 configured to interface with a protocol management system 502 in accordance with the systems and methods described herein. In the example of FIG. 5, a calling party in the external network 504 can send a message to the VB 512. The message can enter the protocol management system 502 through the GA 506. The GA 506 can then send the message to the space 508 where the VBA 510 can retrieve the message and forward the message to the VB 512. The VB 512 can likewise send a message to the calling party in the external network 504 by sending the message to the VBA 510. The VBA 510 then can send the message to the space 508 where the GA 506 can locate the message and forward it to the calling party in the external network 504.

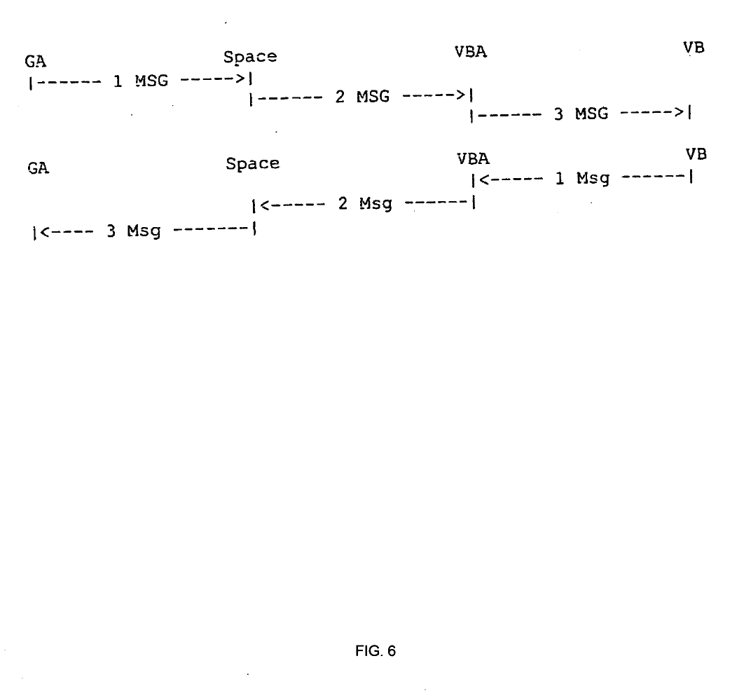

FIG. 6 is a flowchart that illustrates the message sequence between a calling party and a receiving party, or alternatively between a calling party and a third party, or alternatively between a receiving party and a third party, occurring during a communication session and the intermediary devices that receive and forward the messages.

As shown in FIG. 6, the messages can be sent in a straightforward manner without acknowledgement. The messages can be sent from the calling party to pass through the GA, space, and VBA directly to the address of the responding VB. The messages can be sent from the VB to pass through the VBA, space and GA directly to the address of the responding terminal.

As described above, FIG. 2 depicts an exemplary embodiment of a transfer sequence of a communication session occurring between a calling party to a receiving party in an network 200 configured to interface with a protocol management system 202 in accordance with the systems and methods described herein.

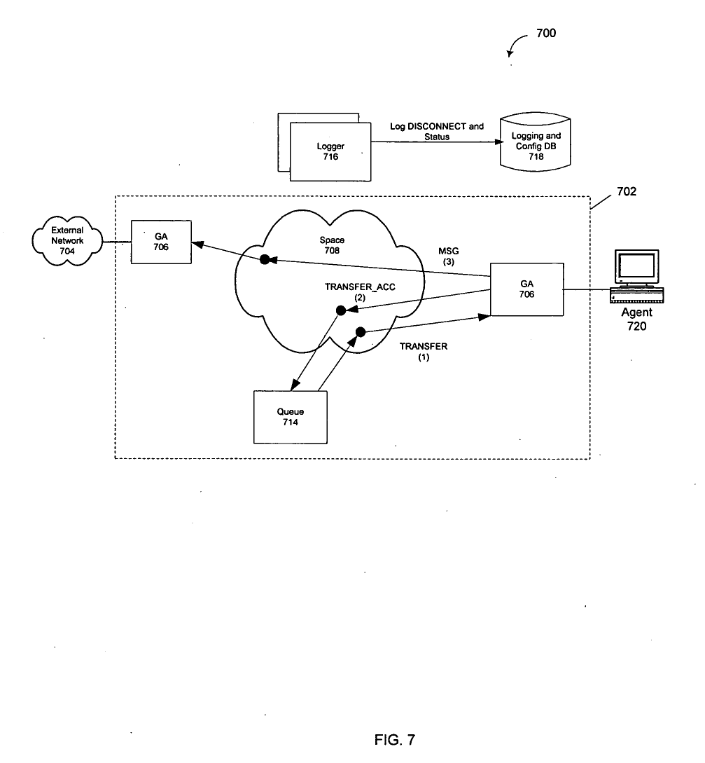

FIG. 7 depicts another exemplary embodiment of a transfer sequence of a communication session occurring between a receiving party to an external third party through a network 700 configured to interface with a protocol management system 702 in accordance with the systems and methods described herein. In the example of FIG. 7, a receiving party in the queue 714 can send a transfer message to a third party agent 720 sitting outside the network 700. The receiving party in the queue 714 can send the transfer message to the space 708 where the GA 706 can retrieve it. The GA 706 can then forward the transfer message to a third party agent 720. The third party agent 720 can reply by sending a transfer accept message to the GA 706. The GA 706 can then forward the transfer accept message to the space 708 where it can be retrieved by the receiving party in the queue 714. The third party agent 720 can then proceed to send messages through the GA 706 and, alternatively through the space 708 and another GA 706, to the calling party in the network 704.

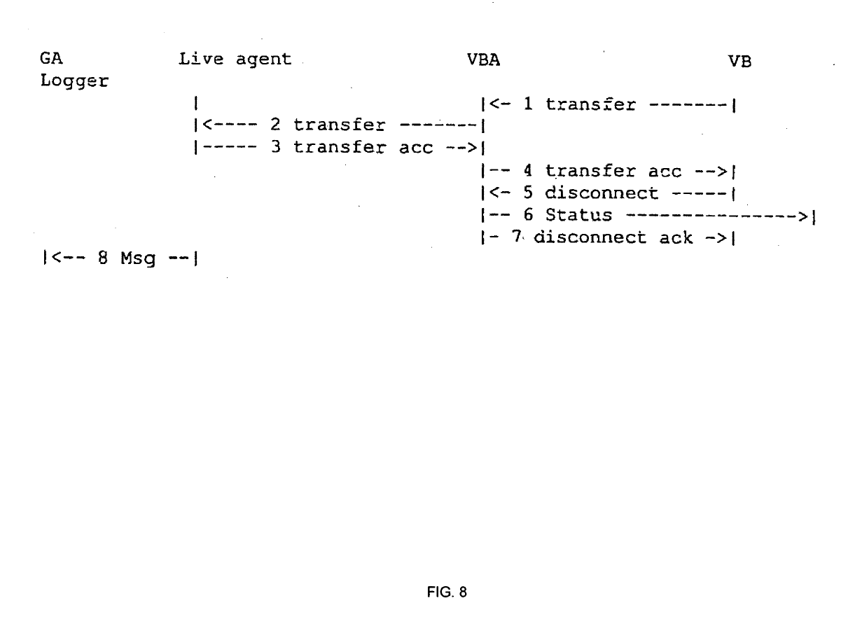

FIG. 8 is a flowchart that illustrates the transfer sequence between a receiving party and a third party, or alternatively between a calling party and a third party, occurring during a communication session and the intermediary devices that receive and forward the messages.

As shown in FIG. 8, the VB can initiate a transfer by sending a transfer message to the VBA. The VBA can forward the message to the space with either the address of a specific third party terminal or the address of a class of terminals. A third party, a live agent, can pick up the transfer message from the space. The live agent can accept the transfer and then can send the VBA a transfer accept message in reply to the transfer message. The VBA can forward the transfer accept message to the VB. The VB can then log is statistics by sending a disconnect message to the VBA with the statistics. The disconnect message can contain a transfer flag property to prevent the disconnect message from being forwarded to the GA. The GA can collect the statistics from the disconnect message and can send the status to the logger. The VBA can send the VB a disconnect acknowledge message.

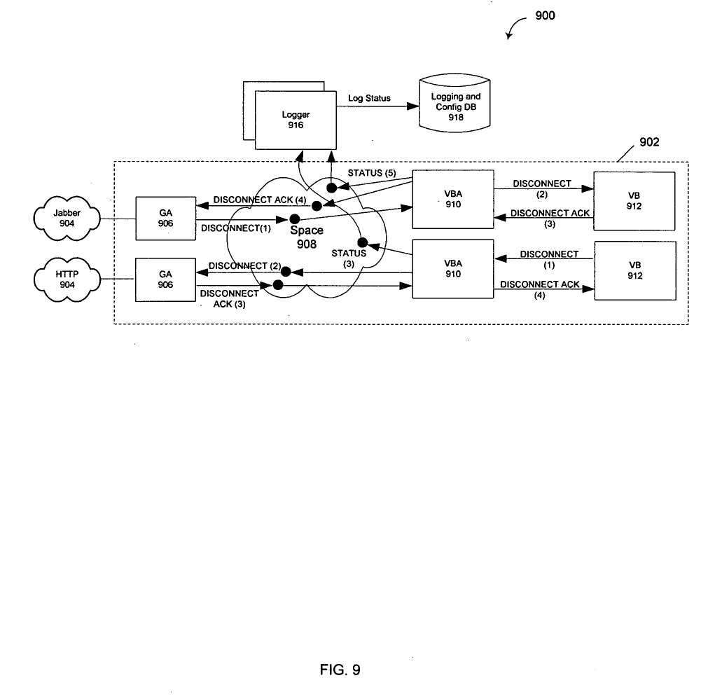

FIG. 9 depicts an exemplary embodiment of a disconnect sequence of a communication session occurring between a calling party to a receiving party and from a receiving party to a calling party in a network 900 configured to interface with a protocol management system 902 in accordance with the systems and methods described herein. In the example of FIG. 9, following the disconnect sequence that can be initiated by a calling party, a calling party using the instant messaging service, Jabber 904, can send a disconnect message to the GA 906. The GA 906 can then send the disconnect message to the space 908 where the VBA 910 can pick it up. The VBA 910 can forward the disconnect message to the VB 912. In reply to the disconnect message, the VB 912 can send a disconnect acknowledgment message including the session statistics to the VBA 910. The VBA 910 can then forward the session statistics to the logger 916 and can forward the disconnect acknowledgment through the space 908 to the GA 906. The GA 906 can then forward the disconnect acknowledgment message further to the calling party using the instant messaging service, Jabber 904.

Alternatively in the example of FIG. 9, the disconnect sequence that can be initiated by a receiving party. The VB 912 can initiate the disconnection by sending a disconnect message with the session statistics to the VBA 910. The VBA 910 then can forward the session statistics to the logger 916. The VBA 910 also can send the disconnect message to the space 908. The GA 906 can pick up the disconnect message from the space 908 and forward the disconnect message to the calling party using the instant messaging service, HTTP 904. The calling party using the instant messaging service, HTTP 904, can then reply be sending a disconnect acknowledgement message through the GA 906 to the space 908. The VBA 910 can then retrieve the disconnect acknowledgment message from the space 908 and forward it to the VB 912.

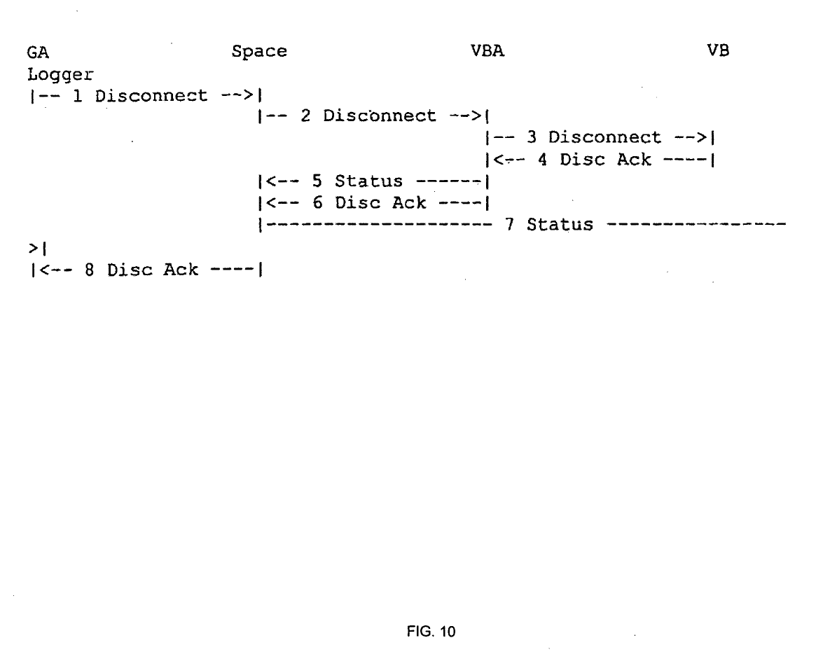

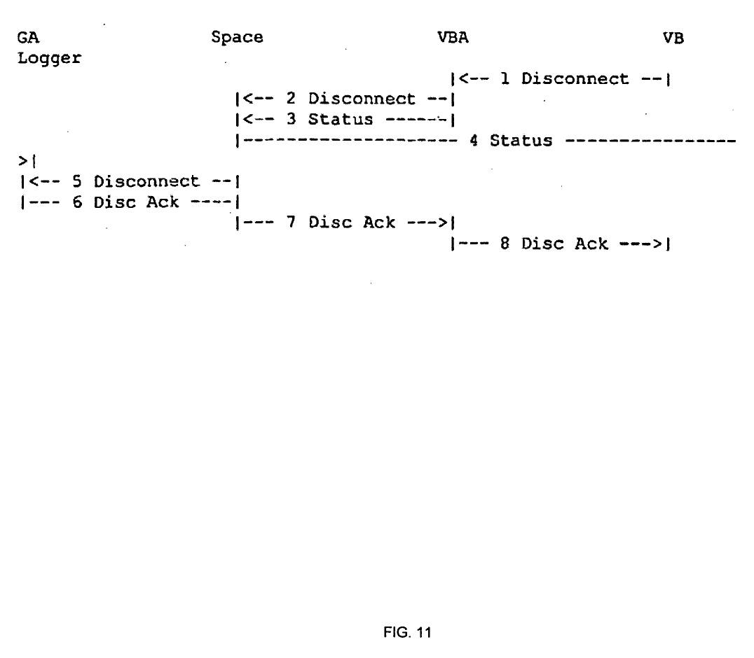

FIGS. 10 and 11 are flowcharts that illustrate the disconnect sequence between any of a receiving party, a calling party, and a third party, occurring during a communication session and the intermediary devices that receive and forward the messages. The disconnect message terminates the connection. Either party may initiate the disconnect.

As shown in FIG. 10, either the GA or the calling party can initiate the disconnect by sending a disconnect message. The GA can forward the disconnect message to the space. The VBA can pick up the disconnect message from the space and forwards it to its VB. The VB can then send a disconnect acknowledgment message that can contain the session statistics to the VBA that then can forward the disconnect acknowledgment message to the space. The session statistics can be picked up by the logger. The GA can pick the disconnect acknowledgment message from the space.

As shown in FIG. 11, the VB can initiate the disconnect by sending a disconnect message to the VBA. The disconnect message sent by the VB can contain session statistics. The VBA then can forward the disconnect message to the space and can send the statistics to the logger. The GA can then send a disconnect acknowledge message to the space, where it can be picked up by the VBA and forwarded to the VB.

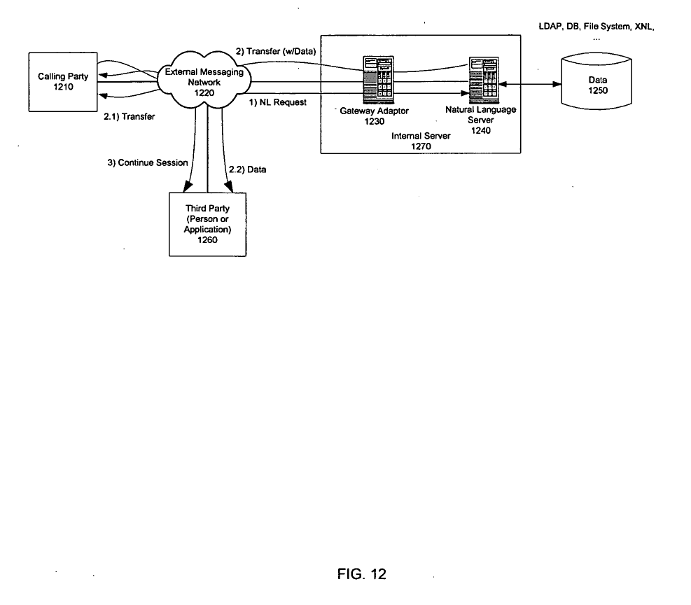

As shown in FIG. 12, a further embodiment of the invention can be a transfer when a calling party of an external messaging network can interact with a natural language application, following which the natural language application can initiate a transfer to a third party client on the same or a different external network. In the example of FIG. 12, a calling party 1210 can send a natural language request to a external messaging network 1220. The external messaging network 1220 can send the natural language request to the internal server 1270 through the gateway adapter 1230 to the natural language server 1240. The natural language server 1240 can retrieve data 1250 and send a transfer message through the gateway adapter 1230 to the external messaging network 1220. The external messaging network 1220 can forward the transfer message with the data, including but not limited to session statistics and the dialog from the communication session, to the third party 1260. The calling party 1210 can be notified of the transfer and can continue the session with the third party 1260 through the external messaging network 1220.

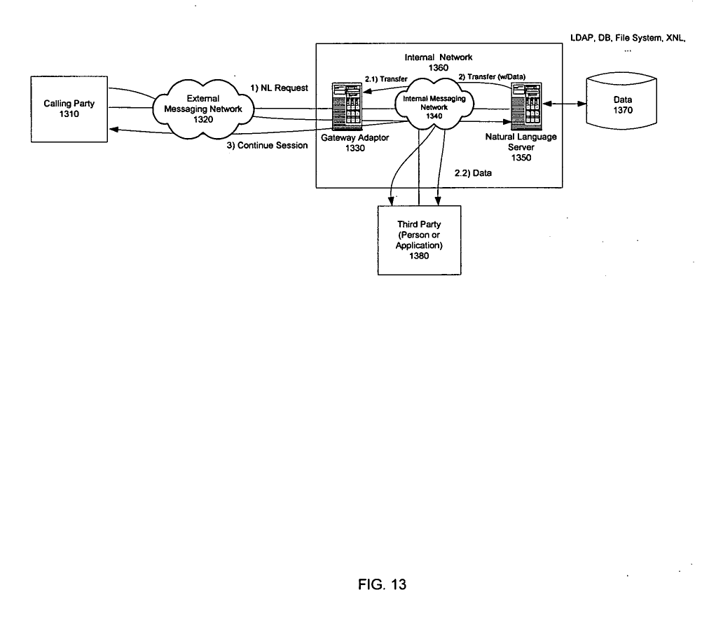

As shown in FIG. 13, a further embodiment of the invention can be a transfer when a calling party of an external messaging network interacts with a natural language application, with the natural language application initiating a transfer to a third party client on an internal messaging network. In the example of FIG. 13, a calling party 1310 can send a natural language request through an external messaging network 1320 to a receiving natural language server 1350. The external messaging network 1320 can forward the natural language request to the internal network 1360 through the gateway adapter 1330. The gateway adapter 1330 can send the natural language request to the internal messaging network 1340. The natural language server 1350 then can retrieve the natural language request and obtain the data 1370 to answer the request. The natural language server 1350 can then transfer the data 1370 and communication session to a third party 1380 coupled to the internal messaging network 1340 by sending a transfer message to the internal messaging network 1340. The third party 1380 then can retrieve the transfer message with data, including but not limited to session statistics and the dialog from the communication session, from the internal messaging network 1340. The gateway adapter 1330 also can retrieve the transfer message without the data and can forward the transfer message to the external messaging network 1320 where the calling party 1310 can pick it up. The calling party 1310 can now continue the session through exchanging messages with the third party 1380.

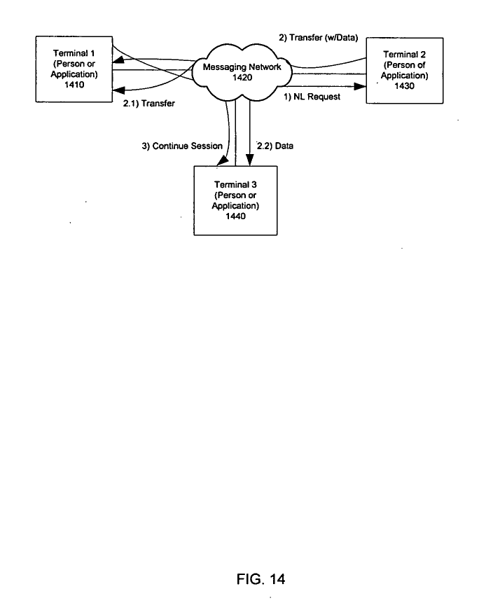

As shown in FIG. 14, a further embodiment of the invention can be a transfer when a first terminal is interacting with second terminal on a messaging network and the second terminal initiates a context sensitive transfer to third terminal where the clients are any mix of people and applications. In the example of FIG. 14, a first terminal 1410 can send a natural language request to a second terminal 1430 through a messaging network 1420. The second terminal 1430 can retrieve the natural language request from the messaging network 1420. The second terminal can send a transfer request with data to a third terminal 1440 by sending the transfer request to the messaging network 1420. The third terminal 1440 can retrieve the transfer with data, including but not limited to session statistics and the dialog from the communication session, from the messaging network and the first terminal 1410 can retrieve the transfer message without data to notify the first terminal 1410 of the transfer. The first terminal 1410 can then engage in a continuation of the communication session with the third terminal 1440 through the messaging network 1420. The second terminal 1430 can be disconnected from the continuing communication session.

In another embodiment, where the application is written in the VoiceXML scripting language, a transfer can be completed using the VoiceXML transfer tag in an IM network. The transfer tag can communicate the name of a transfer variable including busy, noanswer, dest, connecttimeout, and data. The busy variable can indicate the destination resource is busy and cannot accept the transfer request. The noanswer variable can indicate that no transfer response was received within the time specified by connecttime. The dest variable can indicate the destination of the transfer. The connecttimeout variable can indicate the time the platform waits when attempting a connection before aborting the transfer attempt and assigning the transfer variable the value noanswer. The data variable can indicate a block of data to be passed on with the transfer request.

While certain embodiments of the inventions have been described above, it will be understood that the embodiments described are by way of example only. Accordingly, the inventions should not be limited based on the described embodiments. Rather, the scope of the inventions described herein should only be limited in light of the claims that follow when taken in conjunction with the above description and accompanying drawings.

What is claimed:

1. A system configured to perform context sensitive transfers of a communication session comprising:
a first terminal;
a second terminal; and
a third terminal engaged in a communication session with the second terminal, the third terminal configured to:
Initiate a transfer of the communication session to the first terminal by sending a transfer message to the first terminal;
receive a transfer accept message from the first terminal;
send a disconnect message to the second terminal, wherein upon sending the disconnect message, the third terminal is disconnected from the communication session with the second terminal and the communication session continues between the second terminal and the first terminal.

2. The system of claim 1, wherein the communication session is an instant message session.

3. The system of claim 1, wherein the communication session is a SMS session.

4. The system of claim 1, wherein the communication session is an html session.

5. The system of claim 1, wherein the communication session in which the second terminal and the third terminal are engaged in further includes a dialog between the second terminal and the third terminal.

6. The system of claim 5, wherein upon transferring the communication session from the third terminal to the first terminal the dialog between the second terminal and the third terminal also transfers to the first terminal and continues between the second terminal and the first terminal.

7. The system of claim 1, wherein the transfer message comprises:
an identity of a third terminal that is used to establish a connection between the third terminal and the second terminal;
information collected about the second terminal; and
information related to a particular third terminal, or a class of terminals, associated with the communication session.

8. The system of claim 7, wherein the third terminal information includes information related to a particular third party, a specific live person, a class of terminals, or a group of live agents.

9. The system of claim 1, wherein the transfer accept message acts as a reply to the transfer message.

10. The system of claim 9, wherein the transfer accept message enables the second terminal to establish a connection with the first terminal, whereby the first terminal becomes connected to the second terminal and the connection to the third terminal is disconnected.

11. The system of claim 1, wherein the disconnect message terminates the connection between the first and second terminals to enable a first terminal to continue the connection with the second terminal.

12. A system configured to perform context sensitive transfers of a communication session comprising:
a first terminal;
a second terminal; and
a third terminal engaged in a communication session with the second terminal, wherein the first terminal is configured to:
receive a transfer message from the third terminal;
respond to the transfer message by sending a transfer accept message to the third terminal;
connect with the second terminal; and
engage in the communication session with the second terminal.

13. The system of claim 12, wherein upon transferring the communication session from the third terminal to the first terminal the communication session continues between the second terminal and the first terminal.

14. The system of claim 12, wherein the communication session is an instant message session.

15. The system of claim 12, wherein the communication session is a SMS session.

16. The system of claim 12, wherein the communication session in which the second terminal and the third terminal are engaged in further includes a dialog between the second terminal and the third terminal.

17. The system of claim 16, wherein upon transferring the communication session from the third terminal to the first terminal the dialog between the second terminal and the third terminal also transfers and continues between the second terminal and the first terminal.

18. The system of claim 12, wherein the transfer message comprises:
an identity of a second terminal;
information collected about the second terminal; and
a particular third terminal, or class of terminals, associated with the communication session.

19. The system of claim 12, wherein the transfer accept message acts as a reply to the transfer message and enables the second terminal to continue the connection, whereby the first terminal becomes connected to the second terminal and the connection to the third terminal is disconnected.

20. A system configured to perform context sensitive transfers of a communication session comprising:
a first terminal;
a second terminal; and
a third terminal engaged in a communication session with the second terminal, the second terminal configured to:
receive a transfer of the communication session from the third terminal;
disconnect from the communication session with the third terminal;
connect with the first terminal; and
engage in a communication session.

21. The system of claim 20, wherein upon transferring the communication session from the third terminal to the first terminal the communication session continues between the second terminal and the first terminal.

22. The system of claim 20, wherein the communication session is an instant message session.

23. The system of claim 20, wherein the communication session is a SMS session.

24. The system of claim 20, wherein the communication session in which the second terminal and the third terminal are engaged in further includes a dialog between the second terminal and the third terminal.

25. The system of claim 20, wherein upon transferring the communication session from the third terminal to the first terminal the dialog between the second terminal and the third terminal also transfers and continues between the second terminal and the first terminal.

26. A method for transferring a communication session being conducted between a second terminal and a third terminal to a first terminal, the method comprising:
initiating a transfer by sending a transfer message to the first terminal;
disconnecting the third terminal from the second terminal upon receiving a transfer accept message from the first terminal and replacing the third terminal with the first terminal such that the communication session continues between the second and first terminals.

27. The method of claim 26, wherein the transfer message comprises:
an identity of a first terminal;
information collected about the second terminal; and
a particular third terminal, or a class of terminals, associated with the communication session.

28. The method of claim 26, wherein the transfer accept message acts as a reply to the transfer message and enables a third terminal to continue the connection, whereby the third terminal becomes connected to the first terminal and the connection to the second terminal is disconnected.

29. The method of claim 26, wherein the communication session in which the second terminal and the third terminal are engaged in further includes a dialog between the second terminal and the third terminal.

30. The method of claim 26, wherein upon transferring the communication session from a third terminal to a first terminal the dialog between the second terminal and the third terminal also transfers and continues between the second terminal and the first terminal.

31. A transfer protocol of a communication session configured to disconnect the communication session being conducted between a second terminal and a third terminal, the transfer protocol comprising:
a disconnect sequence whereby the third terminal initiates disconnection by sending a disconnect message to the second terminal, the disconnect message being acknowledged by the second terminal; and
a transfer sequence whereby the third terminal sends a transfer message to a first terminal and the first terminal accepts the transfer message and the third terminal sends a disconnect message to the second terminal, wherein the second terminal continues in the communication session with the first terminal.

32. The transfer protocol of claim 31, further comprising:
a connect sequence whereby a second terminal sends a connect message to establish a connection with a third terminal and the third terminal acknowledges the connect message;

33. The transfer protocol of claim 31, further comprising:
a message sequence whereby a second terminal sends the third terminal a message message without acknowledgement and the third terminal sends the second terminal a message message without acknowledgement;

34. The transfer protocol of claim 33, wherein the message sequence comprises:
the second terminal and the third terminal sending messages to the other without regard to the sequence or timing of said messages.

35. The transfer protocol of claim 31, wherein the transfer message comprises:
an identity of a second terminal, or caller, who establishes a connection between a second terminal and a third terminal to initiate a dialog in a communication session;
information collected about the second terminal, or the caller, including the dialog between the second and third terminals;
a particular third party or specific live person, or a class of terminals or group of live agents, where the transfer is to connected to; and
a session identifier defining the connection between the second and third terminals to enable a first terminal to continue the connection.

36. The transfer protocol of claim 31, wherein the disconnect message terminates the connection between the second and third terminals and comprises a session identifier defining the connection between the second and third terminals to enable a first terminal to continue the connection.

37. The transfer protocol of claim 32, wherein the connect message comprises:
an identity of a second terminal, or caller, a connection is being made on behalf of;
a session identifier defining the connection between the second and third terminals;
a destination identifier defining the location of the third terminal;
a source identifier defining the source of the connect message.

38. The transfer protocol of claim 33, wherein the message message comprises:
a body containing text of the message;
a session identifier defining the connection between the second and third terminals;
a destination identifier defining the location of the third terminal;
a source identifier defining the source of the connect message.

39. A system configured to perform context sensitive transfers comprising:
a calling party;
a receiving party, said receiving party configured to,
engage the calling party a communication session wherein the communication session includes dialog between the calling and receiving party, and
transfer the communication session from the calling party to a third party, wherein upon transferring the communication session to the third party, the communication session continues between the third party and the calling party.
